(19) United States
(12) Patent Application Publication
(10) Pub. No.: US 2021/0070925 A1
(43) Pub. Date: Mar. 11, 2021

(54) AQUEOUS POLYMER, DISPERSION, AND AQUEOUS PAINT

(71) Applicant: INDUSTRIAL TECHNOLOGY RESEARCH INSTITUTE, Hsinchu (TW)

(72) Inventors: Cha-Wen CHANG, Zhongpu Township (TW); Ruo-Han YU, Yilan City (TW); Shinn-Jen CHANG, Hsinchu City (TW); Yu-Hui CHEN, Taipei City (TW); Jen-Yu CHEN, New Taipei City (TW)

(73) Assignee: INDUSTRIAL TECHNOLOGY RESEARCH INSTITUTE, Hsinchu (TW)

(21) Appl. No.: 17/011,495

(22) Filed: Sep. 3, 2020

Related U.S. Application Data
(60) Provisional application No. 62/896,067, filed on Sep. 5, 2019.

(30) Foreign Application Priority Data
Jul. 14, 2020 (TW) 109123698

(51) Int. Cl. C08G 61/02; C08K 3/22; C09D 7/61; C09D 175/04

(52) U.S. Cl. CPC C08G 61/02; C08K 3/22; C08K 2003/2244; C09D 175/04; C08K 2003/2241; C09D 7/61

(57) ABSTRACT

An aqueous polymer is formed by neutralizing a copolymer modified by polyalkylene glycol with ammonia, primary amine, secondary amine, inorganic base, or a combination thereof, wherein the copolymer is copolymerized from an anhydride monomer with a double bond, a monomer with a double bond, and an initiator. The aqueous polymer can be mixed and dispersed with water and pigment powder to form a dispersion. The dispersion can be mixed with binder to form an aqueous paint.

### CROSS REFERENCE TO RELATED APPLICATIONS

This application claims the benefit of U.S. Provisional Application No. 62/896,067, filed on Sep. 5, 2019, and claims priority of Taiwan Patent Application No. 109123698, filed on Jul. 14, 2020, the entirety of which are incorporated by reference herein.

### TECHNICAL FIELD

The technical field relates to an aqueous polymer, and in particular it relates to a dispersion and an aqueous paint containing the aqueous polymer.

### BACKGROUND

The global paint market reached a value of 5.7 trillion NTD in 2018, in which white paint was traded highest (about 50%). With improvements in environmental protection awareness, more attention has been paid to the applications of aqueous white slurry (used for primer or color enhancement). White paint needs a white slurry with high tinting ability and high opacity, but these properties are not easily achieved, for the following reasons. Because TiO₂ is easily aggregated and precipitated, it cannot be stably dispersed, and is not compatible with binder, thereby degrading the paint's properties. As such, a dispersant for aqueous white slurry and paint is called for.

### SUMMARY

One embodiment of the disclosure provides an aqueous polymer, being formed by neutralizing a copolymer modified by polyalkylene glycol with ammonia, primary amine, secondary amine, inorganic base, or a combination thereof, wherein the copolymer is copolymerized from an anhydride monomer with a double bond, a monomer with a double bond, and an initiator.

One embodiment of the disclosure provides a dispersion, including an aqueous polymer; water; and pigment powder, wherein the aqueous polymer is formed by neutralizing a copolymer modified by polyalkylene glycol with ammonia, primary amine, secondary amine, inorganic base, or a combination thereof, and wherein the copolymer is copolymerized from an anhydride monomer with a double bond, a monomer with a double bond, and an initiator.

One embodiment of the disclosure provides an aqueous paint, including a dispersion and a binder, wherein the dispersion includes an aqueous polymer; water; and pigment powder, wherein the aqueous polymer is formed by neutralizing a copolymer modified by polyalkylene glycol with ammonia, primary amine, secondary amine, inorganic base, or a combination thereof, wherein the copolymer is copolymerized from an anhydride monomer with a double bond, a monomer with a double bond, and an initiator.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

An aqueous polymer provided by embodiments of the disclosure may serve as dispersant. The aqueous polymer can be mixed with water and pigment powder to form a dispersion. The dispersion can be mixed with a binder to form an aqueous paint.

The aqueous polymer provided by embodiments of the disclosure is formed by neutralizing a copolymer modified by polyalkylene glycol with ammonia, primary amine, secondary amine, inorganic base, or a combination thereof, wherein the copolymer is copolymerized from an anhydride monomer with a double bond, a monomer with a double bond, and an initiator. In one embodiment, the anhydride monomer with a double bond and the monomer with a double bond have a molar ratio of 1:3.2 to 1:0.9. In one embodiment, the anhydride monomer with a double bond can be maleic anhydride, methyl maleic anhydride, dimethyl maleic anhydride, or another suitable monomer. In one embodiment, the monomer with a double bond can be ethylene, propylene, isobutylene, methacrylic acid, acrylic acid, styrene, methyl methacrylate, methyl acrylate, ethyl methacrylate, ethyl acrylate, another suitable monomer, or a combination thereof. In one embodiment, the initiator can be dibenzamidine peroxide, 2,2′-azobisisobutyronitrile, di(t-butyl) peroxide, t-butylhydroperoxide, 1,1′-azo(cyanocyclohexane), 2,5-dimethyl-2,5-bis(t-butyl peroxide) hexane, t-butyl pexoyxbenzoate, cumenehydroperoxide, dicumyl peroxide, lauryl peroxide, t-butyl peroxyacetate, or another suitable initiator. In one embodiment, the polyalkylene glycol and the anhydride monomer have a molar ratio of 0.1:1 to 0.5:1. In one embodiment, the polyalkylene glycol can be methoxypolyethylene glycol (MPEG), other suitable polyalkylene glycol, or a combination thereof. It should be noted that if the copolymer modified by the polyalkylene glycol is neutralized with tertiary amine, the aqueous polymer after being heated will undergo obvious yellowing, influencing the color of the final product.

In one embodiment, the aqueous polymer has a chemical structure of

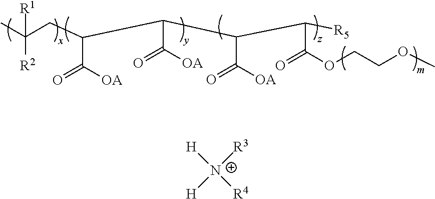

wherein R¹ is H or methyl group, R² is C₆₋₁₂ aryl group, C₃₋₁₂ heteroaryl group, C₂₋₁₀ aliphatic group, —(C═O)—OA, or a combination thereof, R³ is H, C₁₋₄ alkyl group, or C₁₋₄ alkyl alcohol; R⁴ is H, C₁₋₄ alkyl group, or C₁₋₄ alkyl alcohol; R⁵ is H, methyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group; each of A is independently ^{⊖} or H, and at least one of A is ^{⊖}; x is 8 to 30; y is 3 to 9; z is 1 to 5; and m is 10 to 70. If x is too low, the polymer cannot adsorb onto the pigment powder easily. If x is too high, the hydrophilicity of the polymer will be degraded. If y is too low, the hydrophilicity of the polymer will be degraded. If y is too high, the polymer cannot provide efficient steric effect. If z is too low, the hydrophilicity of the polymer will be degraded. If z is too high, the required amount of polymer will be increased to disperse the pigment powder. If m is too low, the polymer cannot provide efficient steric effect. If m is too high, the amount of dispersion pigment powder will be lowered.

In one embodiment, 0.1≤z/(y+z)≤0.5, which means that the grafting ratio is 10% to 50%. When the z/(y+z) ratio is too high, it means that the grafting ratio of the polyalkylene glycol is too high, and the water resistance of a coating including the aqueous polymer will be poor. When the z/(y+z) ratio is too low, it means that the grafting ratio of the polyalkylene glycol is too low, and the pigment powder cannot be efficiently dispersed. In one embodiment, the aqueous polymer has an acid value of 40 mgKOH/g to 300 mgKOH/g.

In one embodiment, the aqueous polymer has a theoretical number average molecular weight (Mn) of 2500 g/mole to 16000 g/mole. For example, the aqueous polymer may have Mn of 2500 g/mol to 7500 g/mole, 7500 g/mole to 9000 g/mole, 9000 g/mole to 12000 g/mole, or 12000 g/mole to 16000 g/mole. If Mn of the aqueous polymer is too low or too high, the pigment powder cannot be efficiently dispersed.

In one embodiment, the method of synthesizing the aqueous polymer is as below. It should be noted that the following method is only for illustration rather than limiting the disclosure. One skilled in the art may adopt applicable apparatuses and chemicals to synthesize the aqueous polymer. First, an anhydride monomer with a double bond and a monomer with a double bond in the presence of dicumyl peroxide (serving as initiator) are copolymerized in cumene (serving as solvent) to form a copolymer, as shown below:

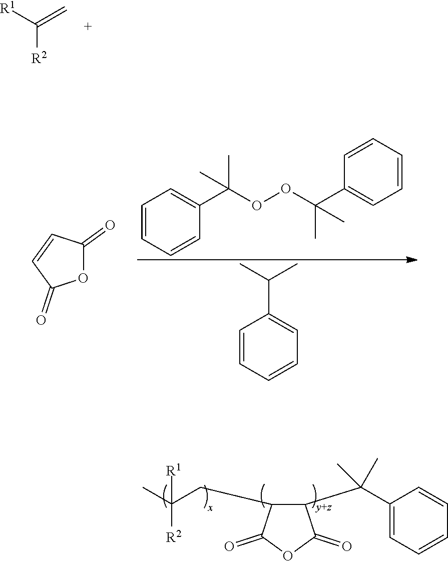

The above polymerization mechanism is radical polymerization, but the disclosure is not limited thereto. For example, one skilled in the art may adopt another initiator to perform the radical polymerization, or another polymerization mechanism such as reversible addition-fragmentation chain transfer (RAFT) polymerization or another applicable polymerization mechanism. The copolymer can be block copolymer, alternating copolymer, or random copolymer. In some embodiments, the copolymer can be directly commercially available rather than self-synthesized.

Subsequently, the copolymer can be modified by polyalkylene glycol (e.g. grafting the polyalkylene glycol to the copolymer), as shown below.

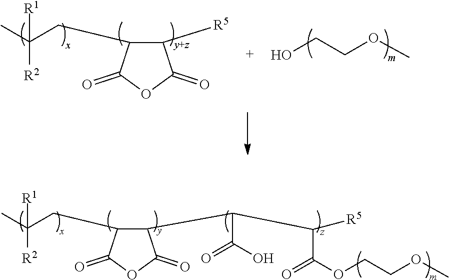

In the above formula, the repeating units corresponding to x, y, and z are arranged in an alternating or random manner rather than a block manner. In one embodiment, catalyst can be further added to promote polymerization. The catalyst can be p-toluenesulfuric acid (PTSA), methanesulfonic acid, sulfuric acid, or hydrochloric acid. In general, the grafting distribution of the polyalkylene glycol is uniform, which is beneficial to uniformly disperse the pigment powder. For example, the aqueous polymer may have a polydispersity index (PDI, Mw/Mn) of 1.0 to 2.0. If the PDI of the aqueous polymer is too high, it means that the grafting positions of the polyalkylene glycol is overly non-uniform, which is unfavorable in the dispersing application.

Subsequently, the copolymer modified by the polyalkylene glycol is neutralized with ammonia, primary amine, secondary amine, inorganic base, or a combination thereof, for example, as shown below.

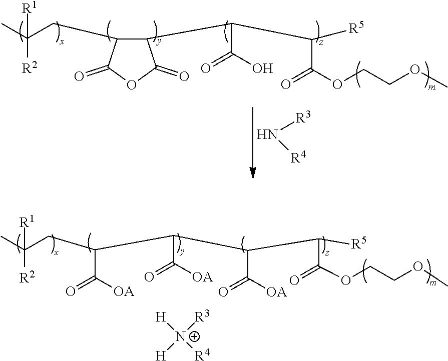

Note that some may be still rather than ^{⊖}. In other words, not a —COOH group is neutralized to —COO^{⊖} and NH₂(R³)(R⁴)^{⊕}.

The inorganic base can be potassium hydroxide (KOH), sodium hydroxide (NaOH), sodium carbonate (Na₂CO₃), sodium bicarbonate (NaHCO₃), potassium carbonate (K₂CO₃), potassium bicarbonate (KHCO₃), barium carbonate (BaCO₃), barium hydroxide (Ba(OH)₂), cesium hydroxide (CsOH), or cesium carbonate (Cs₂CO₃).

The polymer can be used to disperse pigment powder. For example, a dispersion in one embodiment of the disclosure may contain the aqueous polymer, water, and the pigment powder. In one embodiment, the pigment powder may occupy 70 wt % to 81 wt % of the dispersion. If the amount of the pigment powder is too high, the viscosity of the dispersion will be too high and the too less solvent will be easily dried to precipitate the pigment powder. If the amount of the pigment powder is too low, the product practicability will be lowered. In one embodiment, the pigment powder and the active moiety of the aqueous polymer may have a weight ratio of 100:0.4 to 100:3, such as 100:0.4 to 100:1, or 100:1 to 100:3. If the amount of the aqueous polymer is too low, the pigment powder cannot be efficiently dispersed. If the amount of the aqueous polymer is too high, the cost will be increased without further dispersing the pigment powder. In the dispersion, the pigment powder may have an average diameter of 280 nm to 400 nm. In general, the smaller average diameter of the pigment powder is better. In addition, the dispersion may have a viscosity of 30 cps to 120 cps at a rotation speed of 1000 rpm. In addition, the dispersion can be stored at room temperature for a period longer than one year, and the viscosity and the pigment powder diameter thereof are maintained without being greatly changed. Obviously, the dispersion has a very excellent stability.

In addition, the dispersion can be mixed with a binder to form an aqueous paint. The binder can be poly(acrylic acid) resin, polyurethane resin, or a combination thereof. In one embodiment, the dispersion and the binder may have a weight ratio of 30:70 to 55:45. If the amount of the binder is too low, the adhesion of the pigment powder will be degraded. If the amount of the binder is too high, the properties of the pigment powder will not be easily appeared. For example, the dispersion can be mixed with a commercially available binder such as VSR-50 (commercially available from Dow Chemical), ESP-2293 (commercially available from ESP materials), SP3901 (commercially available from Gelie Chemical), or 2026c (commercially available from UNION CHEMICAL IND. CO., LTD.), thereby forming the aqueous paint. The pigment volume concentration (PVC) of the pigment powder in the aqueous paint can be 15% to 30%. If the PVC is too low, the opacity of the aqueous paint will be lowered. If the PVC is too high, the paint gloss will be degraded. In the aqueous paint, the average diameter of the pigment powder can be 280 nm to 550 nm. In general, if the average diameter of the pigment powder in the aqueous paint is greatly larger than the average diameter of the pigment powder in the dispersion, the dispersant (such as the aqueous polymer) may have poor compatibility with the binder. In some embodiments, the average diameter of the pigment powder in the aqueous paint and the average diameter of the pigment powder in the dispersion may have a difference of less than 5%.

The aqueous paint is coated on a substrate and then baking dried to form a film having excellent gloss and opacity. On the other hand, the aqueous polymer has a low yellowing degree after being heated. In short, the aqueous polymer of the disclosure is an appropriate dispersant for the pigment powder, and the dispersion containing the aqueous polymer is proper to prepare the aqueous paint.

In the described embodiments, the main pigment powder is TiO₂ powder serving as white pigment. However, the aqueous polymer is not limited to disperse the TiO₂ powder. For example, the pigment powder can be yellow inorganic pigment such as cadmium yellow (PY35, C.I. 77205, CAS #12237-67-1), titanium nickel yellow (PY53, C.I.77788, CAS #8007-18-9), praseodymium zirconium yellow (PY159, C.I.77997, CAS #68187-15-5), chromium titanium yellow (PY162, C.I.77896, CAS #68611-42-7; PY163, C.I.77897, CAS #68186-92-5), or bismuth yellow (PY184, C.I.771740, CAS #14059-33-7); magenta inorganic pigment such as iron red (PR101, C.I.77491, CAS #1317-60-8), cadmium red (PR108, C.I.77202, CAS #58339-34-7), lead chromium red (PR104, C.I.77605, CAS #12656-85-8; PR105, C.I.77578, CAS #1314-41-6), or iron zirconium red (PR232, C.I.77996, CAS #68412-79-3); cyan inorganic pigment such as cobalt blue (PB28, C.I.77364, CAS #68187-40-6) or cobalt chromium blue (PB36, C.I.77343, CAS #68187-11-1); black inorganic pigment such as manganese iron black (PBK26, C.I.77494, CAS #68186-94-7; PBK33, C.I.77537, CAS #75864-23-2), cobalt iron chromium black (PBK27, C.I.77502, CAS #68186-97-0), copper chromium black (PBK28, C.I.77428, CAS #68186-91-4), chromium iron black (PBK30, C.I.77504, CAS #71631-15-7), or titanium black (PBK35, C.I.77890, CAS #70248-09-8); white inorganic pigment such as titanium white (PW6, C.I.77891, CAS #13463-67-7), zirconium white (PW12, C.I.77990, CAS #1314-23-4), or zinc white (PW4, C.I.77947, CAS #1314-13-2); orange inorganic powder such as cadmium orange (PO20, C.I.77199, CAS #12656-57-4) or orange chromium yellow (PO21, C.I.77601, CAS #1344-38-3); or green inorganic pigment such as chromium green (PG17, C.I.77288, CAS #1308-38-9), cobalt green (PG19, C.I.77335, CAS #8011-87-8), cobalt chromium green (PG26, C.I.77344, CAS #68187-49-5), or cobalt titanium green (PG50, C.I.77377, CAS #68186-85-6). The pigment powder can be another suitable pigment, and not limited to the described pigments.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1-1 (Aqueous Polymer 1d′ and 1d″)

80 g of styrene-maleic anhydride copolymer SMA® 1000 (40 mmole, commercially available from Cray Valley) was added to 120 mL of tetrahydrofuran (THF) under nitrogen, and then heated to 50° C. and stirred until SMA® 1000 was completely dissolved in THF. On the other hand, 192 g of methoxy polyethylene glycol MPEG1200 (160 mmole, commercially available from Sino-Japan Chemical Co., Ltd.) was added to a mixture of 100 mL of THE and 100 mL of n-butyl acetate, and then heated and stirred until MPEG1200 was completely dissolved in the mixed solvent system of THE and n-butyl acetate. The MPEG1200 solution was added to SMA® 1000 solution at 80° C. and reacted for 22 hours. The IR spectrum of SMA® 1000 had C═O signal (1778 cm⁻¹) of the maleic anhydride. The IR spectrum of the intermediate product of the above reaction had COOH signal (3444 cm⁻¹), CH₂ signal (2871 cm⁻¹), C═O signal of ester bond (1733 cm⁻¹), and C—O—C signal (1108 cm⁻¹). As seen in the IR spectra, the MPEG1200 and the maleic anhydride of SMA® 1000 were reacted to perform a ring-opening addition reaction.

The solvent in the reaction result was then removed by rotatory evaporator, and 200 g of the concentrate was added to a mixture of 184 g of water and 26 g of ammonia (28%), and then stirred until the concentrate was completely dissolved to obtain aqueous polymer 1d′ (solid content: 48.8%). The grafting ratio of MPEG1200 was about 45%, and the acid value of the aqueous polymer 1d′ was about 100 mgKOH/g to 120 mgKOH/g. The reaction is shown below, and x, y, z, m, and A correspond to the composition and amount of reactants. x is about 9 to 12, y is about 4 to 6, z is about 4, m is about 25 to 28, and A is substantial ^{⊖}.

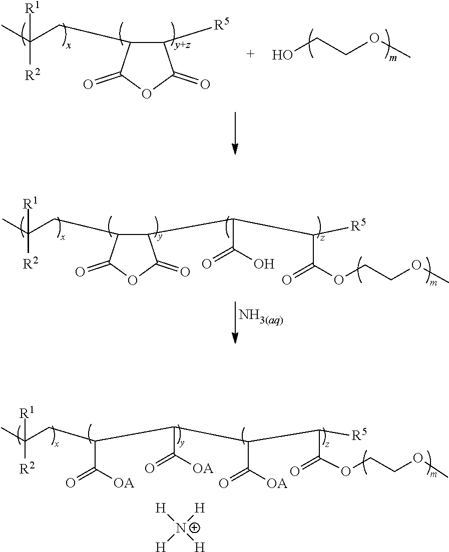

Alternatively, 40 g of the concentrate was added to a mixture of 31 g of water and 12 g of tri ethanol amine, and then stirred the concentrate was completely dissolved to obtain aqueous polymer 1d″ (solid content. 48.2%). The reaction is shown below, and x, y, z, m, and A correspond to the composition and amount of reactants. x is about 9 to 12, y is about 4 to 6, z is about 4, m is about 25 to 28, and A is substantial ^{⊖}.

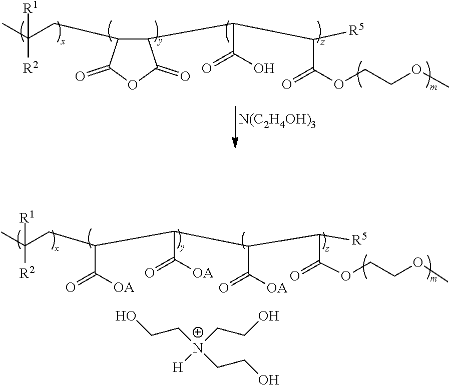

### Example 1-2 (Aqueous Polymer 2D′)

80 g of SMA® 1000 (40 mmole) was added to 220 mL of methyl ethyl ketone (MEK) under nitrogen, and then heated and stirred until SMA® 1000 was completely dissolved in MEK. On the other hand, 320 g of MPEG2000 (160 mmole, commercially available from Sino-Japan Chemical Co., Ltd.) was added to 200 mL of MEK, and then heated and stirred until MPEG2000 was completely dissolved in MEK. The MPEG2000 solution was added to SMA® 1000 solution at 85° C. and reacted for 9 hours. The solvent in the reaction result was removed by rotatory evaporator, and the concentrate was added to a mixture of 426 g of water and 36 g of ammonia (28%), and then stirred until the concentrate was completely dissolved to obtain a dispersant (e.g. aqueous polymer 2d′, solid content: 46.4%). The grafting ratio of MPEG2000 was about 45%, and the acid value of the dispersant was about 65 mgKOH/g to 85 mgKOH/g. The reaction can refer to the reaction formula in Example 1-1, and x, y, z, m, and A correspond to the composition and amount of reactants. x is about 9 to 12, y is about 4 to 6, z is about 4, m is about 43 to 46, and A is substantial ^{⊖}.

### Example 1-3 (Aqueous Polymer 3d′)

40 g of SMA® 1000 (20 mmole) was added to 100 mL of MEK under nitrogen, and then heated and stirred until SMA® 1000 was completely dissolve in MEK. On the other hand, 342 g of MPEG2000 (171 mmole) was added to 300 mL of MEK, and then heated and stirred until MPEG2000 was completely dissolved in MEK. The MPEG2000 solution was added to SMA® 1000 solution at 85° C. and reacted for 9 hours. The solvent in the reaction result was removed by rotatory evaporator, and the concentrate was added to a mixture of 466 g of water and 18 g of ammonia (28%), and then stirred until the concentrate was completely dissolved to obtain aqueous polymer 3d′(solid content: 44.1%). The grafting ratio of MPEG2000 was about 100%, and the acid value of the dispersant was about 20 mgKOH/g to 40 mgKOH/g. The reaction can refer to the reaction formula in Example 1-1, and x, y, z, m, and A correspond to the composition and amount of reactants. x is about 9 to 12, y is about 0, z is about 8 to 12, m is about 43 to 46, and A is substantial ^{⊖}.

### Example 1-4 (Aqueous Polymer 4d′)

150 g of SMA® 1000 (75 mmole) was added to 200 mL of MEK under nitrogen, and then heated and stirred until SMA® 1000 was completely dissolved in MEK. On the other hand, 225 g of MPEG750 (300 mmole) and 3.75 g of PTSA (19.7 mmole) were added to 300 mL of MEK, and then heated and stirred until MPEG750 was completely dissolved in MEK. The MPEG750 solution was added to SMA® 1000 solution at 80° C. and reacted for 9 hours. The solvent in the reaction result was removed by rotatory evaporator, and the concentrate was added to a mixture of 346 g of water and 66 g of ammonia (28%), and then stirred the concentrate was completely dissolved to obtain aqueous polymer 4d′(solid content: 47.9%). The grafting ratio of MPEG750 was about 45%, and the acid value of the aqueous polymer 4d′ was about 140 mgKOH/g to 160 mgKOH/g. The reaction can refer to the reaction formula in Example 1-1, and x, y, z, m, and A correspond to the composition and amount of reactants. x is about 9 to 12, y is about 4 to 6, z is about 4, m is about 15 to 18, and A is substantial ^{⊖}.

### Example 1-5 (Aqueous Polymer 5d′)

200 g of SMA® 1000 (100 mmole) was added to 300 mL of MEK under nitrogen, and then heated and stirred until SMA® 1000 was completely dissolved in MEK. On the other hand, 150 g of MPEG750 (200 mmole) and 3.50 g of PTSA (18.4 mmole) were added to 200 mL of MEK, and then heated and stirred until MPEG750 was completely dissolved in MEK. The MPEG750 solution was added to SMA® 1000 solution at 80° C. and reacted for 8 hours. The solvent in the reaction result was removed by rotatory evaporator, and the concentrate was added to a mixture of 346 g of water and 101 g of ammonia (28%), and then stirred until the concentrate was completely dissolved to obtain aqueous polymer 5d′(solid content: 44.2%). The grafting ratio of MPEG750 was about 20%, and the acid value of the aqueous polymer 5d′ was about 235 mgKOH/g to 255 mgKOH/g. The reaction can refer to the reaction formula in Example 1-1, and x, y, z, m, and A correspond to the composition and amount of reactants. x is about 9 to 12, y is about 6 to 8, z is about 2, m is about 15 to 18, and A is substantial 0).

### Example 1-6 (Aqueous Polymer 6d′)

250 g of SMA® 1000 (125 mmole) was added to 350 mL of MEK under nitrogen, and then heated and stirred until SMA® 1000 was completely dissolved in MEK. On the other hand, 150 g of MPEG1200 (125 mmole) and 4.00 g of PTSA (21 mmole) were added to 200 mL of MEK, and then heated and stirred until MPEG1200 was completely dissolved in MEK. The MPEG1200 solution was added to SMA® 1000 solution at 80° C. and reacted for 8 hours. The solvent in the reaction result was removed by rotatory evaporator, and the concentrate was added to a mixture of 378 g of water and 136 g of ammonia (28%), and then stirred until the concentrate was completely dissolved to obtain aqueous polymer 6d′(solid content: 44.0%). The grafting ratio of MPEG1200 was about 10%, and the acid value of the aqueous polymer 6d′ was about 275 mgKOH/g to 295 mgKOH/g. The reaction can refer to the reaction formula in Example 1-1, and x, y, z, m, and A correspond to the composition and amount of reactants. x is about 9 to 12, y is about 7 to 9, z is about 1, m is about 25 to 28, and A is substantial E).

### Example 1-7 (Aqueous Polymer 7d′)

50 g of SMA® 2000 (16.7 mmole) was added to 120 mL of MEK under nitrogen, and then heated and stirred until SMA® 2000 was completely dissolved in MEK. On the other hand, 100 g of MPEG2000 (50 mmole) and 1.50 g of PTSA (7.89 mmole) were added to 120 mL of MEK, and then heated and stirred until MPEG2000 was completely dissolved in MEK. The MPEG2000 solution was added to SMA® 2000 solution at 80° C. and reacted for 10 hours. The solvent in the reaction result was removed by rotatory evaporator, and 50 g of the concentrate was added to a mixture of 60 g of water and 6 g of ammonia (28%), and then stirred until the concentrate was completely dissolved to obtain aqueous polymer 7d′(solid content: 43.1%). The grafting ratio of MPEG2000 was about 30%, and the acid value of the aqueous polymer 7d′ was about 90 mgKOH/g to 110 mgKOH/g. The reaction can refer to the reaction formula in Example 1-1, and x, y, z, m, and A correspond to the composition and amount of reactants. x is about 19 to 21, y is about 6 to 8, z is about 3, m is about 43 to 46, and A is substantial ^{⊖}.

### Example 1-8 (Amphiphilic Polymer 8d′)

30 g of SMA® 1000 (15 mmole) was added to 60 mL of MEK under nitrogen, and then heated and stirred until SMA® 1000 was completely dissolved in MEK. On the other hand, 11 g of MPEG750 (15 mmole, commercially available from Sino-Japan Chemical Co., Ltd.) and 21 g of dodecylamine (113 mmole) were added to 60 mL of MEK, and then heated and stirred until MPEG750 and dodecylamine were completely dissolved in MEK. 0.6 g of p-toluenesulfonic acid was added to the MPEG750 and dodecylamine solution. The MPEG750, dodecylamine, and p-toluenesulfonic acid solution was added to SMA® 1000 solution at 80° C. and reacted for 5 hours. The solvent in the reaction result was removed by rotatory evaporator, and the concentrate was added to a mixture of 548 g of water and 10 g of ammonia (28%), and then stirred until the concentrate was completely dissolved to obtain amphiphilic polymer 8d′ (solid content: 10%). The reaction is shown below, and x, y, z, z′, m, and A correspond to the composition and amount of reactants. x is about 9 to 12, y is about 0, z is about 1, z′ is about 7 to 9, m is about 15 to 18, and A is substantial ^{⊖}.

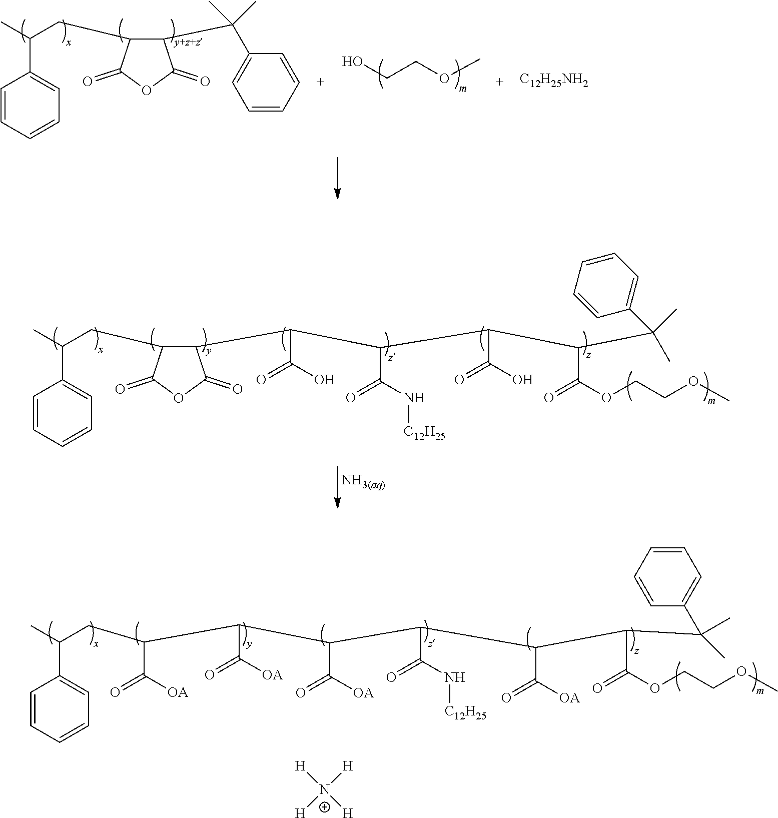

### Example 2-1 (Aqueous Dispersion LAW348a)

The aqueous polymer 1d′ serving as dispersant, TiO₂ powder (Kronos 2360, commercially available from Kronos, purity=92%), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW348a). In the white slurry, TiO₂ occupied 76.5 wt %, the aqueous polymer 1d′ occupied 0.765 wt %, and water occupied the remaining part.

### Example 2-2 (Aqueous Dispersion LAW294a)

Commercially available dispersant Disperbyk-190 (commercially available from BYK), TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW294a). In the white slurry, TiO₂ occupied 76.5 wt %, the commercially available dispersant Disperbyk-190 occupied 0.765 wt %, and water occupied the remaining part.

### Example 2-3 (Aqueous Dispersion LAW295a)

Commercially available dispersant Disperbyk-199 (commercially available from BYK), TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW295a). In the white slurry, TiO₂ occupied 76.5 wt %, the commercially available dispersant Disperbyk-199 occupied 0.765 wt %, and water occupied the remaining part.

### Example 2-4 (Aqueous Dispersion LAW243a)

The aqueous polymer 2d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW243a). In the white slurry, TiO₂ occupied 76.5 wt %, the aqueous polymer 2d′ occupied 0.765 wt %, and water occupied the remaining part.

### Example 2-5 (Aqueous Dispersion LAW245a)

The aqueous polymer 3d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW245a). In the white slurry, TiO₂ occupied 76.5 wt %, the aqueous polymer 3d′ occupied 0.765 wt %, and water occupied the remaining part.

### Example 2-6 (Aqueous Dispersion LAW349a)

The aqueous polymer 1d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW349a). In the white slurry, TiO₂ occupied 80 wt %, the aqueous polymer 1d′ occupied 0.4 wt %, and water occupied the remaining part.

### Example 2-7 (Gel LAW261a)

Commercially available dispersant Disperbyk-190 (commercially available from BYK), TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was gelled (i.e. Gel LAW261a) and could not be filtered through a filtering cloth with pores of 25 m. In the gel, TiO₂ occupied 80 wt %, the commercially available dispersant Disperbyk-190 occupied 0.4 wt %, and water occupied the remaining part.

### Example 2-8 (Gel LAW263a)

Commercially available dispersant Disperbyk-199 (commercially available from BYK), TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was gelled (i.e. Gel LAW263) and could not be filtered through a filtering cloth with pores of 25 m. In the gel, TiO₂ occupied 80 wt %, the commercially available dispersant Disperbyk-199 occupied 0.4 wt %, and water occupied the remaining part.

### Example 2-9 (Aqueous Dispersion LAW282a)

The aqueous polymer 4d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW282a). In the white slurry, TiO₂ occupied 76.5 wt %, the aqueous polymer 4d′ occupied 0.765 wt %, and water occupied the remaining part.

### Example 2-10 (Aqueous Dispersion LAW284a)

The aqueous polymer 5d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW284a). In the white slurry, TiO₂ occupied 76.5 wt %, the aqueous polymer 5d′ occupied 0.765 wt %, and water occupied the remaining part.

### Example 2-11 (Aqueous Dispersion LAW286a)

The aqueous polymer 6d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW286a). In the white slurry, TiO₂ occupied 76.5 wt %, the aqueous polymer 6d′ occupied 0.765 wt %, and water occupied the remaining part.

### Example 2-12 (Aqueous Dispersion LAW273a)

Commercially available dispersant Solsperse™ 20000 (commercially available from Lubrizol), TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW273a). In the white slurry, TiO₂ occupied 76.5 wt %, the commercially available dispersant Solsperse™ 20000 occupied 0.765 wt %, and water occupied the remaining part.

### Example 2-13 (Aqueous Dispersion LAW293a)

Commercially available dispersant Dispex® Ultra PX 4575 (commercially available from BASF), TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW293a). In the white slurry, TiO₂ occupied 76.5 wt %, the commercially available dispersant Dispex® Ultra PX 4575 occupied 0.765 wt %, and water occupied the remaining part.

### Example 2-14 (Aqueous Dispersion LAW308a)

The aqueous polymer 7d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was filtered through a filtering cloth with pores of 25 m to obtain a white slurry (i.e. aqueous dispersion LAW308a). In the white slurry, TiO₂ occupied 76.5 wt %, the aqueous polymer 7d′ occupied 0.765 wt %, and water occupied the remaining part.

### Example 2-15 (Gel LAW331a)

The amphiphilic polymer 8d′ serving as dispersant, TiO₂ powder (Kronos 2360), and water were stirred to pre-disperse. Zirconia beads were added to the pre-dispersion, and the above mixture was put into a LAU disperser to be dispersed by vibration at room temperature for 8 hours. After the vibration was completed, the vibrated result was gelled (i.e. Gel LAW331a) and could not be filtered through a filtering cloth with pores of 25 m. In the gel, TiO₂ occupied 76.5 wt %, the amphiphilic polymer 8d′ occupied 0.765 wt %, and water occupied the remaining part.

The average diameter (Dₐᵥₑ), D₉₅, and D₁₀₀ of solid particles (e.g. TiO₂) of the aqueous dispersions, and the viscosity of the aqueous dispersions at a rotation speed of 1000 rpm and a temperature of 25° C. were measured, as tabulated in Table 1.

TABLE 1

| Example | Dispersion | Dispersant | Dₐᵥₑ (nm) | D₉₅ (nm) | D₁₀₀ (nm) | η (cps) |
|---|---|---|---|---|---|---|
| 2-1 | LAW348a | 1d′ | 292 | 575 | 955 | 42 |
| 2-2 | LAW294a | BYK190 | 337 | 591 | 825 | 49 |
| 2-3 | LAW295a | BYK199 | 339 | 611 | 955 | 55 |
| 2-4 | LAW243a | 2d′ | 317 | 818 | 1480 | 61 |
| 2-5 | LAW245a | 3d′ | 387 | 807 | 1280 | 68 |
| 2-6 | LAW349a | 1d′ | 307 | 626 | 1110 | 43 |
| 2-9 | LAW282a | 4d′ | 329 | 587 | 825 | 54 |
| 2-10 | LAW284a | 5d′ | 332 | 689 | 1110 | 58 |
| 2-11 | LAW286a | 6d′ | 340 | 708 | 1110 | 76 |
| 2-12 | LAW273a | Lubrizol2000 | 404 | 712 | 1110 | 86 |
| 2-13 | LAW293a | BASF4575 | 685 | 1180 | 1720 | 55 |
| 2-14 | LAW308a | 7d′ | 309 | 569 | 825 | 50 |

| | | | | | |
|---|---|---|---|---|---|
| Commercially available | — | 319 | 516 | 712 | 37 |
| white slurry Kronos4311 | | | | | |

As shown above, the aqueous polymers having a lower grafting ratio (e.g. the aqueous polymers d′, 2d′, 4d′, 5d′, 6d′, and 7d′) serving as the dispersant prepared in Examples of the disclosure had a better dispersing effect for TiO₂ powder. The aqueous polymers having a higher grafting ratio (e.g. the aqueous polymers 3d′) serving as the dispersant prepared in Example of the disclosure and the commercially available dispersant had a worse dispersing effect for TiO₂ powder (e.g. larger average diameter).

Example 3-1 (Aqueous white paint S86) 6.4 g of the aqueous dispersion LAW348a and 13.6 g of the binder VSR-50 (commercially available from Dow Chemical) were mixed, in which the pigment volume concentration was 18%. The mixture was stirred at a rotation speed of 800 rpm to 1000 rpm for 0.5 hours to obtain an aqueous white paint S86.

Example 3-2 (Aqueous white paint S87) 9.1 g of the aqueous dispersion LAW348a and 10.9 g of the binder VSR-50 were mixed, in which the pigment volume concentration was 28%. The mixture was stirred at a rotation speed of 800 rpm to 1000 rpm for 0.5 hours to obtain an aqueous white paint S87.

Example 3-3 (Aqueous white paint S13) 6.6 g of the commercially available white slurry Kronos 4311 and 13.4 g of the binder VSR-50 were mixed, in which the pigment volume concentration was 18%. The mixture was stirred at a rotation speed of 800 rpm to 1000 rpm for 0.5 hours to obtain an aqueous white paint S13.

### Example 3-4 (Aqueous White Paint S14)

9.4 g of the commercially available white slurry Kronos 4311 and 10.6 g of the binder VSR-50 were mixed, in which the pigment volume concentration was 28%. The mixture was stirred at a rotation speed of 800 rpm to 1000 rpm for 0.5 hours to obtain an aqueous white paint S14.

### Example 3-5 (Aqueous White Paint S35)

9.3 g of the aqueous dispersion LAW294a and 10.7 g of the binder VSR-50 were mixed, in which the pigment volume concentration was 28%. The mixture was stirred at a rotation speed of 800 rpm to 1000 rpm for 0.5 hours to obtain an aqueous white paint S35.

### Example 3-6 (Aqueous White Paint S36)

9.3 g of the aqueous dispersion LAW295a and 10.7 g of the binder VSR-50 were mixed, in which the pigment volume concentration was 28%. The mixture was stirred at a rotation speed of 800 rpm to 1000 rpm for 0.5 hours to obtain an aqueous white paint S36.

### Example 3-7 (Aqueous White Paint S88)

8.7 g of the aqueous dispersion LAW348a and 11.3 g of poly(acrylic acid) binder ESP-2293 (commercially available from ESP materials) were mixed, in which the pigment volume concentration was 28%. The mixture was stirred at a rotation speed of 800 rpm to 1000 rpm for 0.5 hours to obtain an aqueous white paint S88.

### Example 3-8 (Aqueous White Paint S89)

8.5 g of the aqueous dispersion LAW348a and 11.5 g of poly(acrylic acid) binder SP-3901 (commercially available from Gelie Chemical) were mixed, in which the pigment volume concentration was 28%. The mixture was stirred at a rotation speed of 800 rpm to 1000 rpm for 0.5 hours to obtain an aqueous white paint S89.

### Example 3-9 (Aqueous White Paint S90)

8.7 g of the aqueous dispersion LAW348a and 11.3 g of polyurethane-type binder 2026C (commercially available from UNION CHEMICAL IND. CO., LTD.) were mixed, in which the pigment volume concentration was 28%. The mixture was stirred at a rotation speed of 800 rpm to 1000 rpm for 0.5 hours to obtain an aqueous white paint S90.

The viscosity (i) of the aqueous white paint at a rotation speed of 1000 rpm and temperature of 25° C. and the average diameter (Davₑ) of the TiO₂ powder in the paint are tabulated in Table 2. The term “(%)” in ADave column means the value of average diameter change of the coating divided by the average diameter of the dispersion and multiplied by 100.

TABLE 2

| | | | Dispersion | Dispersion | | Paint | | |
|---|---|---|---|---|---|---|---|---|
| | | PVC | (White | Dₐᵥₑ | η | Dₐᵥₑ | ΔDₐᵥₑ | η |
| Paint | Dispersant | (%) | slurry) | (nm) | (cps) | (nm) | (nm) | (cps) |
| S86 | 1d′ | 18 | LAW348a | 292 | 42 | 489 | 197 | 38 |
| | | | | | | | (+67%) | |
| S13 | Unknown | 18 | Kronos4311 | 319 | 37 | 642 | 323 | 31 |
| | | | | | | | (+101%) | |
| S87 | 1d′ | 28 | LAW348a | 292 | 42 | 424 | 132 | 25 |
| | | | | | | | (+45%) | |
| S14 | Unknown | 28 | Kronos4311 | 319 | 37 | 657 | 338 | 43 |
| | | | | | | | (+106%) | |
| S88 | 1d′ | 28 | LAW348a | 292 | 42 | 478 | 186 | 43 |
| | | | | | | | (+64%) | |
| S89 | 1d′ | 28 | LAW348a | 292 | 42 | 401 | 109 | 34 |
| | | | | | | | (+37%) | |
| S90 | 1d′ | 28 | LAW348a | 292 | 42 | 302 | 10 | 32 |
| | | | | | | | (+3%) | |

The dispersion formed from the aqueous polymer dispersant prepared in Examples of the disclosure could be mixed with the binder resin to form the paints, and the average diameter of the TiO₂ powder in the paints would not greatly increase (compared to the commercially available white slurry).

### Example 4 (Gloss Comparison)

The aqueous white paint S87 (containing the dispersion 348a) and the aqueous white paint S14 (containing commercially available white slurry Kronos 4311) were respectively coated onto glass substrates by #22 wire rod to form wet films having a thickness of about 50.29 m. The wet films were dried to obtained white films. In a gloss meter ZEHNTNER ZGM 1120, the white films were respectively irradiated by an incident light at an angle of 60° to measure their gloss. The white film formed from the aqueous white paint S87 had a gloss of 90.6 GU, and the white film formed from the aqueous white paint S14 had a gloss of 62.2 GU. Obviously, the aqueous polymer prepared in Examples of the disclosure could be used for the aqueous white paint to efficiently increase the product gloss.

### Example 5 (Opacity Comparison)

The aqueous white paint S86 (containing the dispersion LAW348a), the aqueous white paint S13 (containing the commercially available white slurry Kronos 4311), the aqueous white paint S87 (containing the dispersion LAW348a), the aqueous white paint S14 (containing the commercially available white slurry Kronos 4311), the aqueous white paint S35 (containing the dispersion LAW294a), and the aqueous white paint S36 (containing the dispersion LAW295a) were respectively coated on BYK opacity test papers (PA-2814) by #22 wire rod to form wet films having a thickness of 50.29 m. The wet films were dried to obtain white films. The opacity of the white films was measured with image analyzer QEA IAS according to the standard ASTM D2805. In the aqueous white paint having a pigment volume concentration of 18%, the white film formed from the aqueous white paint S86 had a reflectivity (Y value) of 83.3 on the black bottom and a reflectivity (Y value) of 90.5 on the white bottom, which means that the white film had an opacity of 92.0%; and the white film formed from the aqueous white paint S13 had a reflectivity (Y value) of 82.0 on the black bottom and a reflectivity (Y value) of 90.7 on the white bottom, which means that the white film had an opacity of 90.4%. In the aqueous white paint having a pigment volume concentration of 28%, the white film formed from the aqueous white paint S87 had a reflectivity (Y value) of 85.3 on the black bottom and a reflectivity (Y value) of 91.1 on the white bottom, which means that the white film had an opacity of 93.6%; the white film formed from the aqueous white paint S14 had a reflectivity (Y value) of 85.6 on the black bottom and a reflectivity (Y value) of 91.9 on the white bottom, which means that the white film had an opacity of 93.1%; the white film formed from the aqueous white paint S35 had a reflectivity (Y value) of 84.6 on the black bottom and a reflectivity (Y value) of 91.5 on the white bottom, which means that the white film had an opacity of 92.5%; and the white film formed from the aqueous white paint S36 had a reflectivity (Y value) of 84.1 on the black bottom and a reflectivity (Y value) of 91.8 on the white bottom, which means that the white film had an opacity of 91.6%. Accordingly, the aqueous polymer prepared in Examples of the disclosure could be used in aqueous white paint to efficient increase the product opacity.

### Example 6

The aqueous white paints S87, S14, S35, and S36 were respectively coated by #22 wire rod to form films to measure their chromaticity coordinates (X, Y, Z). The films were then heated to 210° C. and kept for 1 and 2 hours to measure their chromaticity coordinates again. The product utilizing the aqueous polymer 1d′ prepared by Example as the dispersant had a lower yellowing degree (e.g. ΔYI), and the products containing the commercially available dispersant BYK190 or BYK199 or the commercially available white slurry Kronos 4311 had a higher yellowing degree. For example, the film formed from the white paint S87 had a ΔYI value of 1.5 (zero grade yellowing, or no color change) after being heated for 1 hour, and a ΔYI value of 5.5 (second grade yellowing, or slight color change) after being heated for 2 hours. The film formed from the white paint S14 had a ΔYI value of 4.6 (second grade yellowing, or slight color change) after being heated for 1 hour, and a ΔYI value of 14.7 (fifth grade yellowing, or serious color change) after being heated for 2 hours. The film formed from the white paint S35 had a ΔYI value of 2.5 (first grade yellowing, or very slight color change) after being heated for 1 hour, and a ΔYI value of 7.5 (third grade yellowing, or obvious color change) after being heated for 2 hours. The film formed from the white paint S36 had a ΔYI value of 5.7 (second grade yellowing, or slight color change) after being heated for 1 hour, and a ΔYI value of 11.6 (fourth grade yellowing, or great color change) after being heated for 2 hours. ΔYI value (yellow difference) is defined as below: YI=100(1.30*X−1.13*Z)/Y, ΔYI=(YI after heating)−(YI before heating). ΔYI≤1.5 is zero grade, which means no color change. 1.6<ΔYI≤3.0 is first grade, which means very slight color change. 3.1<ΔYI≤6.0 is second grade, which means slight color change. 6.1<ΔYI≤9.0 is third grade, which means obvious color change. 9.1<ΔYI≤12.0 is fourth grade, which means great color change. 12.1<ΔYI is fifth grade, which means serious color change.

### Example 7 (Neutralizers Comparison)

The aqueous polymer 1d′ (neutralized with ammonia) and the aqueous polymer 1d″ (neutralized with triethanolamine) were transparent, clear, and pale yellow. Both of the aqueous polymers 1d′ and 1d″ were heated to 120° C. and kept at 120° C. for 2 hours. The heated aqueous polymer 1d′ was still transparent, clear, and pale yellow. However, the heated aqueous polymer 1d″ changed to dark yellow. Accordingly, the tertiary amine was not suitable to form the aqueous polymer of the disclosure.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An aqueous polymer, being:
formed by neutralizing a copolymer modified by polyalkylene glycol with ammonia, primary amine, secondary amine, inorganic base, or a combination thereof,
wherein the copolymer is copolymerized from an anhydride monomer with a double bond, a monomer with a double bond, and an initiator.

2. The aqueous polymer as claimed in claim 1, having a chemical structure of: 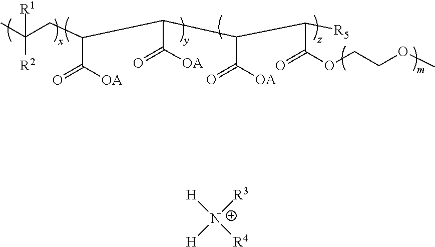
wherein R¹ is H or methyl group;
R² is C₆₋₁₂ aryl group, C₃₋₁₂ heteroaryl group, C₂₋₁₀ aliphatic group, —(C═O)—OA, or a combination thereof,
R³ is H, C₁₋₄ alkyl group, or C₁₋₄ alkyl alcohol;
R⁴ is H, C₁₋₄ alkyl group, or C₁₋₄ alkyl alcohol;
R⁵ is H, methyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group;
each of A is independently ^{⊖} or H, and at least one of A is ^{⊖};
x is 8 to 30;
y is 3 to 9;
z is 1 to 5; and
m is 10 to 70.

3. The aqueous polymer as claimed in claim 1, wherein 0.1≤z/(y+z)≤0.5.

4. The aqueous polymer as claimed in claim 1, having an acid value of 40 mgKOH/g to 300 mgKOH/g.

5. A dispersion, comprising:
an aqueous polymer;
water; and
pigment powder,
wherein the aqueous polymer is formed by neutralizing a copolymer modified by polyalkylene glycol with ammonia, primary amine, secondary amine, inorganic base, or a combination thereof, and
wherein the copolymer is copolymerized from an anhydride monomer with a double bond, a monomer with a double bond, and an initiator.

6. The dispersion as claimed in claim 5, wherein the aqueous polymer has a chemical structure of: 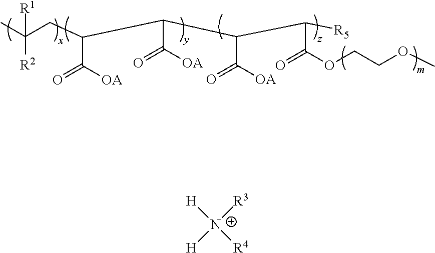
wherein R¹ is H or methyl group;
R² is C₆₋₁₂ aryl group, C₃₋₁₂ heteroaryl group, C₂₋₁₀ aliphatic group, —(C═O)—OA, or a combination thereof,
R³ is H, C₁₋₄ alkyl group, or C₁₋₄ alkyl alcohol;
R⁴ is H, C₁₋₄ alkyl group, or C₁₋₄ alkyl alcohol;
R⁵ is H, methyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group;
each of A is independently ^{⊖} or H, and at least one of A is ^{⊖};
x is 8 to 30;
y is 3 to 9;
z is 1 to 5; and
m is 10 to 70.

7. The dispersion as claimed in claim 5, wherein the pigment powder has an average diameter of 280 nm to 400 nm.

8. An aqueous paint, comprising:
a dispersion and a binder,
wherein the dispersion comprises:
an aqueous polymer;
water; and
pigment powder,
wherein the aqueous polymer is formed by neutralizing a copolymer modified by polyalkylene glycol with ammonia, primary amine, secondary amine, inorganic base, or a combination thereof,
wherein the copolymer is copolymerized from an anhydride monomer with a double bond, a monomer with a double bond, and an initiator.

9. The aqueous paint as claimed in claim 8, wherein the aqueous polymer has a chemical structure of: 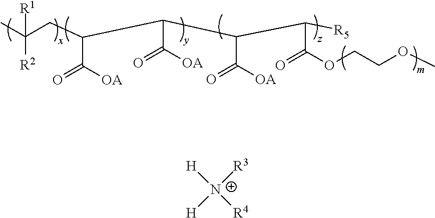
wherein R¹ is H or methyl group;
R² is C₆₋₁₂ aryl group, C₃₋₁₂ heteroaryl group, C₂₋₁₀ aliphatic group, —(C═O)—OA, or a combination thereof;
R³ is H, C₁₋₄ alkyl group, or C₁₋₄ alkyl alcohol;
R⁴ is H, C₁₋₄ alkyl group, or C₁₋₄ alkyl alcohol;
R⁵ is H, methyl group, cumyl group, cumyl ester group, cumyl ether group, t-butyl ether group, benzoate group, cyanocyclohexane group, isobutyronitrile group, C₂₋₁₁ alkyl group, C₂₋₁₁ alkyl ester group, C₆₋₁₂ aryl group, C₃₋₁₂ heteroaryl group, or C₂₋₁₀ aliphatic group;
each of A is independently ^{⊖} or H, and at least one of A is ^{⊖};
x is 8 to 30;
y is 3 to 9;
z is 1 to 5; and
m is 10 to 70.

10. The aqueous paint as claimed in claim 8, wherein the pigment powder has an average diameter of 280 nm to 550 nm.
